(19) United States
(12) Patent Application Publication
(10) Pub. No.: US 2026/0306984 A1
(43) Pub. Date: Oct. 8, 2026

(54) ADD ON AUTO CLEAN ASSEMBLY FOR A VACUUM FILTRATION SYSTEM OF A DRY BULK TRAILER AND METHOD OF USING THE SAME

(71) Applicant: BULK TANK, INC., Park Hills, MO (US)

(72) Inventors: David E. SISK, Bonne Terre, MO (US); Peter KEMP, Crestwood, MO (US)

(21) Appl. No.: 19/685,988

(22) Filed: May 22, 2026

Related U.S. Application Data
(63) Continuation-in-part of application No. 18/714,409, filed on May 29, 2024.
(63) Continuation-in-part of application No. 19/105,633, filed on Feb. 21, 2025.

(51) Int. Cl. B01D 46/00; B01D 46/24; B60P 3/22; B65D 88/54; B65G 53/24

(52) U.S. Cl. CPC B01D 46/0041; B01D 46/2411; B60P 3/2245; B65D 88/548; B65G 53/24; B01D 2273/28; B01D 2279/40

(57) ABSTRACT

An add on assembly is releasably connectable to a dry bulk tank trailer. The trailer has a vacuum line that supplies vacuum pressure to a tank of the trailer to load the tank with dry bulk material conveyed in air drawn by the vacuum pressure from a source of the dry bulk material to the tank. The air drawn to the tank is then drawn through a filter to clean the air. The add on assembly adapts the trailer to reverse the flow of air through the filter to clean the filter.

### CROSS REFERENCE TO RELATED APPLICATIONS

This application is a Continuation-In-Part of application Ser. No. 18/714,409, which was filed on Dec. 30, 2022, and is incorporated herein by reference, and is also a Continuation-In-Part of application Ser. No. 19/105,633, which was filed on Feb. 21, 2025, and is incorporated herein by reference.

### STATEMENT REGARDING FEDERALLY SPONSORED RESEARCH

Not Applicable.

### FIELD

This disclosure relates to a vacuum filtration system and its operation for a dry bulk tank trailer assembly.

### BACKGROUND

Bulk tank trailer assemblies are typically tank trailers for the movement of bulk dry goods such as, for example and without limitation, wheat, corn, flour, plastic pellets, granular materials, or other materials capable of pneumatic conveyance. Bulk tank trailer assemblies typically are loaded and unloaded by pneumatically conveying the material into or out of the tank of the bulk tank trailer assembly. Filtration systems for typical dry bulk tank trailer assemblies separate the air conveying the material from dust and other particles or debris when conveying such materials to and from such vehicles or storage silos, during operations of the system. This allows for capture of the dust of the conveyed material and discharge of filtered air with minimal dust or debris being discharged to the environment. The disclosure also relates to a system and method for cleaning the filter media used in the filtration system.

### DESCRIPTION OF THE DRAWINGS

In the accompanying drawings which form part of the specification:

FIG. 1 is a schematic depiction of a dry bulk tank trailer including a filter system.

FIG. 2 is a left side view of the filtration system and corresponding components of the dry bulk tank trailer shown in FIG. 1.

FIG. 3 is a rear view of the filtration system and corresponding components of the dry bulk tank trailer shown in FIG. 1

FIG. 4 is a right-side view of the filtration system and corresponding components of the dry bulk tank trailer shown in FIG. 1.

FIG. 5 is a top view of the filtration system and corresponding components of the bulk tank trailer shown in FIG. 1.

FIG. 6 is a partial left side view of the canister of the filtration system of FIGS. 2-5.

FIG. 7 is a partial rear view of the canister of the filtration system of FIGS. 2-5.

FIG. 8 is a partial right-side view of the canister of the filtration system of FIGS. 2-5.

FIG. 9 is an isometric view of the canister of the filtration system of FIGS. 2-5.

FIG. 10 is a top view of the canister of the filtration system of FIGS. 2-5.

FIG. 11 is a schematic view of a control system for the filtration system and pneumatic conveyance system of the dry bulk tank trailer shown in FIG. 1.

FIG. 12 is a schematic illustration of the valve states for a plurality of valves when configured for loading the dry bulk tank trailer of FIG. 1.

FIG. 13 is a schematic illustration of the valve states for a plurality of valves when configured for cleaning the filtration system of the dry bulk tank trailer of FIG. 1

FIG. 14 is a schematic depiction of a dry bulk tank trailer similar to that of FIG. 1 but showing the Add On Auto Clean Assembly added to the trailer.

FIG. 15 is a schematic depiction of the Add On Auto Clean Assembly of FIG. 14 removed from the trailer.

FIG. 16 is a schematic depiction of the Add On Auto Clean Assembly of FIG. 15 with the manually operated valves of FIG. 15 replaced with electrically operated valves and with a filter assembly removably connected to the Add On Auto Clean Assembly.

FIG. 17 is a schematic depiction of a perspective view of a Stand Alone Add On Auto Clean Assembly.

FIG. 18 is a schematic depiction of a side elevation view of the Stand Alone Add On Auto Clean Assembly of FIG. 17.

FIG. 19 is a schematic depiction of a side elevation view of the Stand Alone Add On Auto Clean Assembly similar to that of FIG. 18 but showing manually operate valves and a separate blower as a vacuum pressure source.

In the figures, corresponding reference characters and symbols indicate corresponding parts in the several views of the drawings.

### DETAILED DESCRIPTION

The following detailed description illustrates the disclosed systems and methods by way of example and not by way of limitation. The description enables one skilled in the art to make and use the disclosed apparatuses and the methods, describes several embodiments, adaptations, variations, alternatives, and uses of the same, including what is presently believed to be the best mode of making and using the apparatuses.

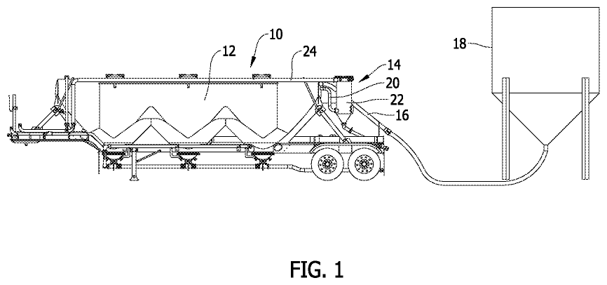

Referring generally to FIG. 1, a dry bulk trailer 10 is shown according to one embodiment. The dry bulk trailer 10 includes a tank 12 for storing the dry bulk material, a filtration system 14 for filtering air being discharged to the environment, and a fill pipe 16 for receiving material from a source 18 (e.g., a storage silo, a dry bulk tank, railcar, tank trailer, dry bulk trailer, or other storage system or source of material). The dry bulk trailer 10 is adapted and configured to receive and discharge bulk dry goods (e.g., in a granular form) using pneumatic conveyance. As air is used to convey the material into and out of the tank 12 of the dry bulk trailer 10, the air is discharged to the environment from the tank 12 at some point during operation in order to either create a vacuum within the tank 12 to draw material into the tank or to relieve pressure within the tank in the case in which material is blown into the tank creating positive pressure in the tank. The air being discharged from the tank is filtered. The filtration systems and pneumatic conveyance systems (e.g., an air mover and/or the filtration system) of various configurations of the dry bulk trailer 10 fall, generally, into three types.

A first type uses a vacuum, as previously noted, to draw the material into the tank 12 for storage. More specifically, the combined vacuum filtration system and pneumatic conveyance system uses a source of vacuum, such as a blower to draw fluidized granular material, using air in which the material is mixed and suspended, from a storage container, such as a silo, through the fill pipe 16 into the tank 12 of the dry bulk trailer 10. As the granular material is moved into the tank 12 dusty air enters and/or is created within the tank 12. The dusty air is processed by the filtration system 14. In processing by the filtration system 14, the dusty air within the tank 12 goes through a dusty air line 20 into a filter canister 22 where it passes through filtration media 23, such as filter tubes, filter bags, pleated cartridge filters, or other filter media positioned within the filter canister 22. The filter media 23 divides an interior volume of the canister 22 into a dusty air DA side and a clean air CA side on opposite sides of the filter media 23. The granular material cannot pass through the filter media 23 and is deposited on the filter media 23 and/or drops down into the bottom of the filter canister 22 in the dusty air DA side of the canister interior volume. The air, with granular material at least partially removed, passes through the filter media 23. The filtered air then goes through a vacuum line or pipe 24 to a blower (not shown), or other vacuum source connected in communication with the vacuum line 24, providing the vacuum, where the filtered air is discharge to atmosphere. The rest of the dust collects on the bottom of the filter canister. The dust collected on the filter media 23 decreases the ability of the air to pass through the filter media 23 and increases the back pressure through the system increasing the amount of time required to completely load the trailer. In other words, the buildup of dust on the filter media 23 impedes airflow through the filter media 23 and thereby decreases the ability of the blower to evacuate or draw air from the tank and build vacuum in the tank which reduces the effectiveness of the pneumatic conveyance. It is therefore desirable to remove the collected dust from the filter media 23 and from the filter canister 22.

A second type of filtration system and pneumatic conveyance system pressurizes the storage container 18, such as a silo, with a pressure source, such as a blower, to push granular product suspended in pressurized air through the fill pipe 16 into the tank 12 of dry bulk tank trailer 10. The dusty air then goes through the dusty air pipe 20 into the filter canister 22, where it is filtered in the same manner as just described with respect to the first type of system using a vacuum to pneumatically convey the material. The filtered air from the filter is then discharged to atmosphere.

A third type of filtration system and pneumatic conveyance system uses a pressure source, such as a blower, pushes granular material into a storage container, such as a silo, the dusty air then goes into the dusty air line 20 of the filter 14 and is filtered. The filtered air then is discharged to atmosphere.

In operation of all types of pneumatic conveyance systems, filtering the conveying air to remove the dust is beneficial because the dust can become trapped in the close clearances of a blower (e.g., when the blower is providing vacuum for conveying the material) causing the blower to seize thereby damaging the blower, or the drive system of the blower. In some embodiments, the blower (not shown) is driven by a tractor (not shown) for towing the dry bulk trailer 10. For example, and without limitation, the tractor may drive the blower using a power take off which is optionally driven by an internal combustion engine of the tractor. Alternatively, the blower can be driven by an electric motor or otherwise be suitably driven to move air. Additionally, dust released to atmosphere is an inhalation hazard, and explosion hazard

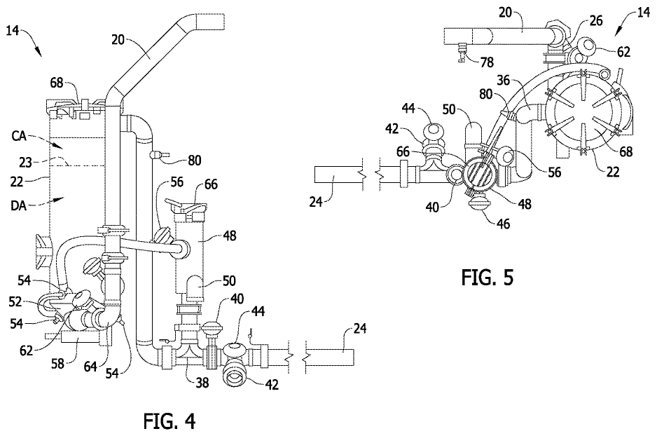

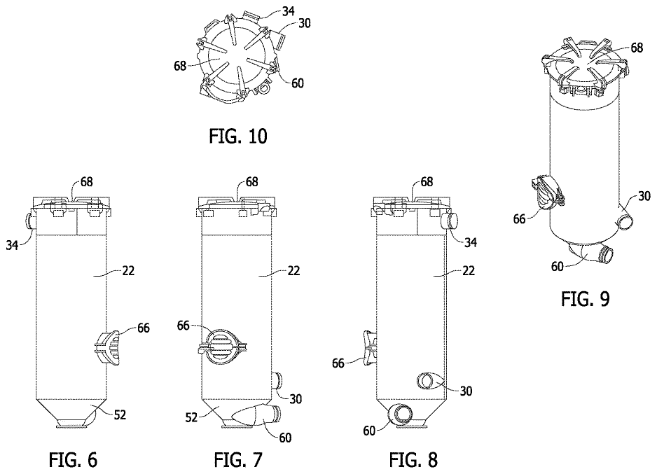

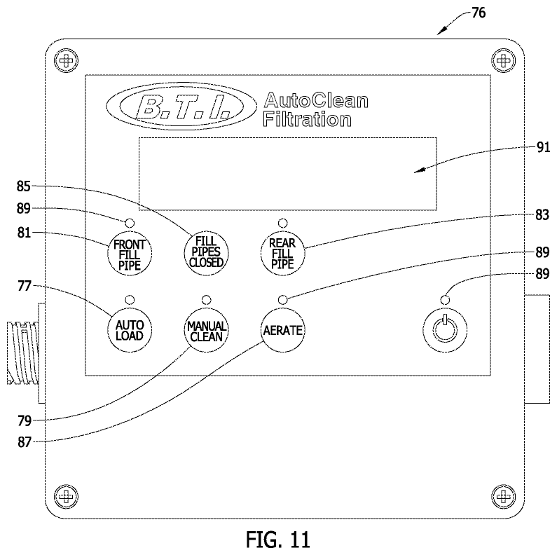

Referring generally to FIGS. 1-13, the preferred embodiment of the bulk tank trailer 10 and associated systems (e.g., the filtration system 14 and pneumatic conveyance system) operate using a vacuum as described with respect to the first type of filtration and conveyance system previously described. Referring to FIGS. 1-5 and 12-13, the vacuum filter system 14 is shown in greater detail according to one embodiment. A blower (not shown) is connected in fluid communication with the vacuum line 24 to provide a source of vacuum through the vacuum line 24 to the connected filtration system 14 and which is used in conveying material into the tank 12 when loading the dry bulk trailer 10. The blower being connected through the vacuum line 24 in fluid communication with the filtration system 14 and other components of the dry bulk trailer 10 (e.g., tank 12 and fill pipe 16) allows for removal of air from the tank 12 and drawing in of air into the tank 12 through the fill pipe 16 connected to and between the material source 18 and the tank 12 along with material from the material source 18 (e.g., a silo). The air conveying the material (and the material) enters the tank 12. The material conveyed fills the tank 12 and dusty air is pulled by the blower from the tank 12 into the dusty air line (or dusty air inlet) pipe 20 of the filtration system 14 connected to the tank 12.

The filtration system 14 further includes a dusty air line fitting 26 (e.g., a Y fitting or other suitable fitting) connected to and between the dusty air line 20 and the tank 12 and the filter system 14 for splitting the dusty air line 20. Connected in fluid communication with the Y fitting 26, and by extension the dusty air line 20, is a first branch from the dusty air line 20, i.e., a dusty air inlet line or pipe 28 connected between the Y fitting 26 and the canister 22 of the filter system 14. The dusty air inlet line or pipe 28 is connected in fluid communication with a dusty air inlet 30 on the filter canister 22 of the filter system 14. The dusty air inlet 30 is an opening or port on the filter canister 22 that allows for dusty air from the dusty air line pipe 20 to enter the filter canister 22 for filtering of the dusty air. In some embodiments, a dusty air inlet line valve 32 is positioned and connected between the Y fitting 26 and the dusty air inlet 30 on the filter canister 22. The dusty air inlet line valve 32 is any suitable valve for controlling the flow of dusty air through the dusty air inlet 30 on the canister 22. For example, the dusty air inlet line valve 32 can be a quarter turn butterfly valve actuated manually, pneumatically, electrically, or otherwise manipulable to control flow.

The filtration system 14 further includes filter media 23 positioned within the filter canister 22. This can be any suitable filter media for filtering particulate from air. The filter media 23 in the interior volume of the filter canister 22 separates an interior area of the filter canister 22 communicating with the dusty air inlet 30 on the canister 22, or a dusty air DA side of the interior volume of the canister 22 from an interior area of the filter canister 22 communicating with a clean air outlet 34 on the canister 22, or a clean air CA side of the interior volume of the filter canister 22. The filter media prevents at least some dust, particulate, granular material, or other solids entrained in the air pneumatically conveying material into the tank 12 and then into the filter canister 22 from passing through the filter. Filtered air passing through the filter media 23 enters an interior area of the filter canister 22 separated from the dusty air inlet 30 by the filter media. Filtered air can then exit the filter canister through a clean air outlet 34 and enter a clean air line 36 or pipe connected to the outlet 34. In some embodiments, the filter canister 22 and the filter media are of the type described in Applicants U.S. patent application Ser. No. 17/300,958, assigned to the assignee of this application and incorporated herein by reference. The clean air line 36 is in fluid communication with the clean air outlet 34 and by extension the filter canister 22. The clean air line 36 extends from the canister 22 and connects in fluid communication with a clean air line fitting 38. The clean air line fitting 38 has three branches that are connected in fluid communication. The clean air line fitting 38 is, in some embodiments, a Y fitting or a T fitting, but can be any suitable fitting. The clean air line fitting 38 has a first branch or first end connected in fluid communication with the vacuum line or pipe 24 and allows for fluid communication with a vacuum source such as a blower. The clean air line fitting 38 is also connected by a second branch or end in a separate fluid communication with a source of atmospheric air (filtered or unfiltered in different embodiments). The third branch of the clean air line fitting is configured for a connection in fluid communication with the clean air line 36.

The filtration system 14 further includes vacuum line 24 connected in fluid communication with the first branch or end of the clean air line fitting 38. The vacuum line 24 is connected in fluid communication with the vacuum source (e.g., a blower on a truck cab connected to the trailer) such that air is evacuated from the tank 12 through the dusty air line 20, through the filter canister 22, through the clean air line 36, through the clean air line fitting 38 and passes through the vacuum line 24 and the vacuum source (e.g., the blower). The vacuum line 24 includes a vacuum shut off valve 40 connected to the vacuum line 24. The vacuum shut off valve 40 is any suitable valve for controlling the flow of air through the vacuum line 24. For example, the vacuum shut off valve 40 can be a quarter turn butterfly valve actuated manually, pneumatically, electrically, or otherwise manipulable to control flow. The vacuum shut off valve 40 can be shut to prevent the building of vacuum within the tank 12 while the blower continues running.

The filtration system 14 further includes a vacuum dump fitting 42 that is connected to and in fluid communication with the vacuum line 24. The vacuum dump fitting 42 is any suitable fitting and can be, for example and without limitation, a T fitting. The vacuum dump fitting 42 provides for a connection between and fluid communication between the vacuum line 24 and a vacuum dump valve 44. The vacuum dump valve 44 is any suitable valve for controlling the flow of air through or into the vacuum dump valve 44, the vacuum fitting 41 and the vacuum line 24. For example, the vacuum dump valve 44 can be a quarter turn butterfly valve actuated manually, pneumatically, electrically, or otherwise manipulable to control flow. The vacuum dump valve 44 is operable to relieve vacuum in the vacuum line 24 when the blower is operated and when the vacuum shut off valve 40 is closed. The vacuum dump valve 44 can be opened to atmosphere communicating the vacuum line 24 to atmosphere when the blower is operating and the vacuum shut off valve 40 is closed. This allows the blower to draw air from atmosphere to cool and reduce strain on the blower rather than continually build vacuum in the vacuum line 24.

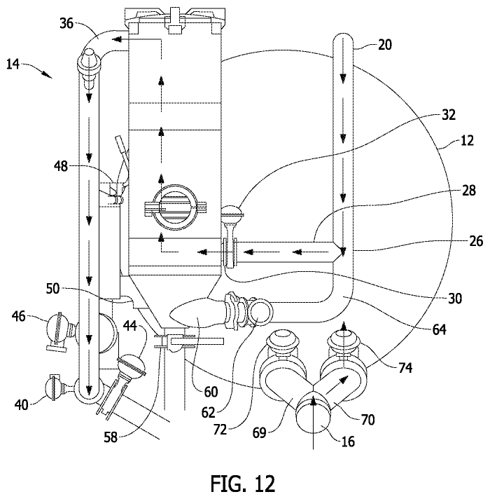

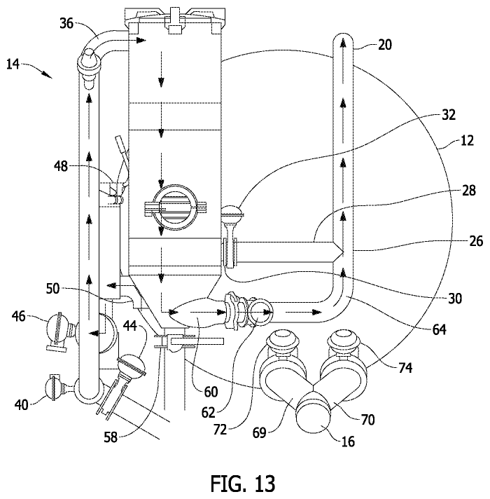

As previously described, the clean air line fitting 38 can be a T fitting with one portion or one end being connected in fluid communication with the vacuum shut off valve 40, the vacuum dump valve 44, and the vacuum line 24. The other portion or other end of the T of the clean air line fitting 38 is connected in fluid communication with an air source such as the atmosphere. This air source provides air for cleaning the filter media within the filter canister 22 which is described in greater detail herein with respect to FIGS. 12 and 13. To clean the filter media, air is provided from the air source through the clean air line fitting 38 and through the clean air line 36 to flow through the filter media in the opposite or reverse direction opposite the air flow when pneumatically conveying material into the tank 12. This reverse flow dislodges material on the filter media thereby cleaning the filter material. The air source can be atmosphere, air ejected from the blower when providing vacuum during loading, air from a separate blower, or other air source. In the depicted embodiment, the air for cleaning the filter media is provided from atmosphere and through a secondary filtration system to reduce foreign debris from entering the filtration system 14 and/or the tank 12 when cleaning the filter media.

An atmospheric inlet valve 46 is connected to and in fluid communication with the second end or branch of the clean air line fitting 38. The atmospheric inlet valve 46 is any suitable valve for controlling the flow or air into the clean air line 36 through the clean air line fitting 38. For example, the atmospheric inlet valve 46 can be a quarter turn butterfly valve actuated manually, remotely and automatically, pneumatically, electrically, or otherwise manipulable to control flow. The atmospheric inlet valve 46 can be closed to allow for the blower to provide a vacuum through the vacuum line 24 for pneumatically conveying material into the tank 12 when loading the tank 12. The atmospheric inlet valve 46 can be opened to provide a source of air for cleaning the filter media as will be described in greater detail with respect to FIGS. 12 and 13. An inlet air filter 48 is connected in fluid communication with the atmospheric inlet valve 46 to provide filtered air to the atmospheric inlet valve 46. The inlet air filter 48 can be any suitable air filter. In the depicted embodiment, the inlet air filter 48 includes a canister and filter media similar to or the same as the filter system previously described with regard to the canister 22. The inlet air filter 48 further includes an inlet 50 that is connected in communication with and allows unfiltered atmospheric air to enter the inlet air filter 48. This air enters an enclosure (e.g., a canister as depicted) and passes through the filter media therein which then exits through the clean air line fitting 38 and into the clean air line 36 when the atmospheric inlet valve 46 is open (as is described in greater detail with respect to FIGS. 12 and 13). This provides a source of clear air for cleaning the filter media in the filter canister 22.

In alternative embodiments, the filtration system 14 omits the inlet air filter 48.

In some embodiments, the filtration system 14 further includes an aeration system. The aeration system can be used to aerate filtered material that collects in the bottom of the canister 22 (e.g., in a conical lower section 52). This is useful in dislodging or otherwise facilitating the removal of the collected material when cleaning the filter media and the canister 22. The aeration system includes a plurality of aerators 54 for introducing air into the collected material to aerate it (e.g., fluidize the material by suspending it in air or otherwise introducing air into the material). Any suitable aerator 54 can be used including, for example and without limitation, the aerator described in Applicant's U.S. Pat. No. 8,087,816, assigned to the assignee of this application and incorporated herein by reference.

The aerators 54 are in fluid communication with an air line for providing air to the aerators. The air line is in turn connected in fluid communication with the inlet air filter 48 such that the aerators 54 can be provided with clean air for introduction into the filter canister 22 and ultimately into the tank 12 as will be described in greater detail later herein with reference to FIGS. 12 and 13. An aeration valve 56 is connected in position between the inlet air filter 48 and the air line supplying the aerators 54. In operation, the air being supplied to the aerators 54 is drawn from the atmosphere as a result of the difference in pressure between the atmosphere and the vacuum in tank 12 which is created during loading of the tank 12. Therefore, opening the aeration valve 56 creates a pressure differential between atmosphere and the vacuum in the tank 12 thus drawing air into the inlet air filter 48 and being supplied to the aerators 54. In embodiments including the aeration system, the aeration system can be activated by opening the aeration valve 56 when there is a vacuum in the tank 12. This can be used in combination with other functions such as the cleaning of the filter media or can be used independently (e.g., in preparation for manually cleaning the filter canister 22 using a clean out valve 58). The clean out valve 58 is any suitable valve and can be, for example, a manually operated butterfly valve.

The filtration system 14 further includes a recycled dust outlet 60 connected to the bottom of the canister 22. The recycled dust outlet 60 allows for dust collected in the filter canister 22 (e.g., including any conical lower section 52) and/or any dust or other material cleaned from the filter media to be removed from the filter canister 22 (e.g., to complete cleaning of the filter system 14). The recycled dust outlet 60 is connected in fluid communication with a dust recycle valve 62. The dust recycle valve 62 is connected in fluid communication with the dust recycle line 64. The dust recycle line 64 is connected in fluid communication with the dusty air line 20 through the fitting 26. As explained in greater detail with reference to FIGS. 12 and 13, this allows for the dust and/or other material cleaned from the filter media and/or canister 22 to be recycled into the tank 12 through reversing the flow through the dusty air line 20 (e.g., which flows dusty air into the filter canister 22 during loading of the tank 12 due to the application of vacuum provided by the blower).

The arrangement as depicted with the separate dusty air inlet line 28 and the separate dust recycle line 64 provide different advantages. Separate lines for input into the canister 22 and output from the canister 22 allows for different placement of the dusty air inlet line 28 and the separate dust recycle line 64 to provide for different advantages. For example, placement of the dust recycle line 64 as low as possible on the canister 22 allows for greater removal of material in the canister 22 (e.g., material positioned below dust recycle line 64 and the recycled dust outlet 60 might not be removed). Thus, the recycled dust outlet 60 and the dust recycle line 64 are in fluid communication with the lower conical section 52 of the canister 22. However, such a placement is less effective for the input of dusty air into the canister 22 for filtering. As dust collects in the canister 22, it can build up and obstruct the inlet supplying dusty air to the filtration system 14 and providing the fluid communication between the blower and the tank 12 and fill pipe 16 providing for pneumatic conveyance of the material. The blockage (partial or complete) impedes the ability of the system to provide vacuum for conveyance of the material. Placement in the lower conical section 52 can also impinge on incoming dusty air given the reduced diameter of the canister 22 where the pipe feeds the canister. The proximity of the canister wall can also cause dust to be more likely to be deposited on the wall. Therefore, there are advantages in having the dusty air inlet 30 positioned higher up relative to the recycled dust outlet 60. This reduces the likelihood that that dusty air inlet 30 becomes blocked.

Using separate dusty air inlet line 28 and the separate dust recycle line 64, along with corresponding dusty air inlet 30 and recycled dust outlet 60, allows for the system to achieve the benefits of both placements for each component. The separate dusty air inlet line 28 can be placed higher up on the canister 22 to reduce blockages. At the same time, the dust recycle line 64 can be placed low on the canister 22 to increase the amount of collected material that is removed when cleaning the filter media and/or the canister 22.

In some embodiments, the dry bulk tank trailer 10 includes a fill system that includes a branching fill pipe 16. The fill pipe 16 branches into a front fill pipe 69 and a rear fill pipe 70. A front fill pipe control valve 72 and a rear fill pipe control valve 74. The front fill pipe control valve 72 can be selectively opened and closed to fill or cease filling a front region of the tank 12 (e.g., with the front fill pipe 69 extending internally within the tank 12 to a region near the front of the tank 12). The rear fill pipe control valve 74 can be selectively opened and closed to fill or cease filling a rear region of the tank 12 (e.g., with the rear fill pipe 70 extending internally within the tank 12 to a region near the rear of the tank 12). The front fill pipe control valve 72 and the rear fill pipe control valve 74 can be any suitable valve for controlling the flow of air and material (e.g., pneumatically conveyed material).

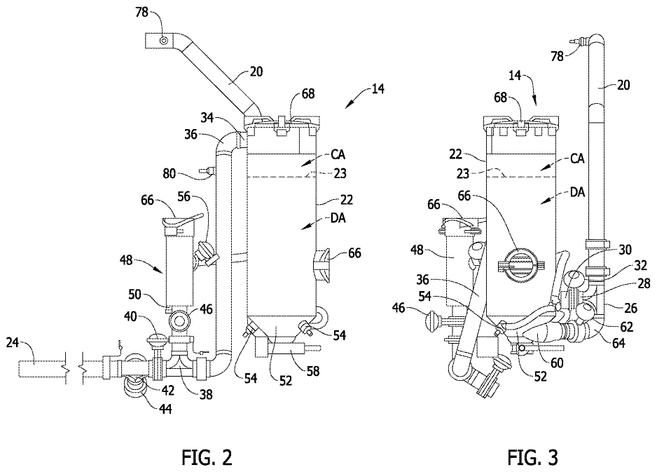

Referring now to FIGS. 2-5 and 11-13, in some embodiments the valves of the filtration system 14 and related systems are manually actuated valves (e.g., butterfly valves that are manually activated using a handle). In the depicted embodiment, many of the valves are electrically activated butterfly valves. This allows for automatic or manual control of the valves. For example, the valves can be electrically activated but only in response to manual control inputs (e.g., through a control system 76). In the preferred embodiment, the filtration system 14, the electrically activated valves (e.g., dusty air inlet valve 32, vacuum shut off valve 40, vacuum dump valve 44, atmospheric inlet valve 46, optional aeration valve 56, dust recycle valve 62, etc.), and the control system 76 allow for some automatic control of the filtration system 14 and the dry bulk trailer 10 as a whole (e.g., for automatic cleaning of the filter media).

To provide for automatic operation, the dry bulk trailer 10 includes a plurality of pressure sensors. A dusty air pressure sensor 78 is connected in fluid communication with the dusty air inlet 20. A clean air pressure sensor 80 is connected in fluid communication with the clean air line 36. Both sensors are any suitable sensor for measuring pressure. In the preferred embodiment, the sensors are of a type suitable to convert a pressure reading to an electric signal (analog or digital) for processing by the control system 76. For example, and without limitation, the sensors can be a piezoresistive strain gauge or type of strain gauge based sensor suitable for measuring the pressure within a pipe or other container. The clean air pressure sensor 80 can be a combined vacuum-pressure sensor with a range of approximately −15 pounds per square inch to 30 pounds per square inch. The clean air pressure sensor 80 can be located at any point on the blower side of the filter media but in the depicted embodiment is connected positioned to measure pressure in the clean air line 36. The dusty air pressure sensor 78 can be a combined vacuum-pressure sensor with a range of approximately −15 pounds per square inch to 30 pounds per square inch. The dusty air pressure sensor 78 can be located at any point connected on the fill pipe 16 side of the filter media but in the depicted embodiment is positioned to measure pressure in the dusty air inlet 20. The dusty air pressure sensor 78 can be used to measure the current pressure in the tank 12 (the dusty air inlet 20 being in fluid communication with the tank 12) which is useful information for the operator of the tank trailer and/or can be used by the control system 76.

The control system 76 utilizes the signals from the dusty air pressure sensor 78 and the clean air pressure sensor 80 to control one or more of the valves of the filtration system 14 and/or the dry bulk trailer 10 in order to provide for the functions described herein (e.g., automatic cleaning on the filter media through the reversal of air flow across the filter media). The control system 76 include or otherwise performs the functions of a data acquisition system, controller for controlling the valves through the provision of control signals (electric, pneumatic, etc.), logic control for the processing of input signals, user input devices for manual control of the valves or the control system itself, displays for conveying information to a user, other input or output devices, input for receiving valve position indicating signals, modules, etc. It should be understood that any suitable combination of systems and/or components can be used to provide for the functions of the control system 76 described herein. For example, the control system 76 can be or ASIC, FPGA, a system-on-chip a processor (shared, dedicated, or group) that performs instructions included in code, including for example, execution of executable code instructions and/or interpretation/translation of uncompiled code, memory for storage of code, instructions, or the like for execution by the processor, communications hardware, or other suitable hardware components that provide the described functionality.

In operation, the control system 76 can provide for automatic filtration system 14 cleaning cycles. For example, this operation can be triggered by receiving a user input through an autoload button 77. While the tank 12 is being loaded, the control system 76 receives signals from the dusty air pressure sensor 78 and the clean air pressure sensor 80 corresponding to the pressure in the dusty air inlet 20 and the clean air line 36. The control system 76 subtracts the pressure values corresponding to the two signals to determine the differential pressure between the dusty air inlet 20 and the clean air line 36. This differential pressure corresponds to the differential pressure across the filter media and/or between the input and output of the filter canister 22. When the control system 76 determines that the differential pressure meets or exceeds a threshold value, the control system 76 actuates the appropriate valves through corresponding control signals to clean the filter media as will be described in greater detail with respect to FIGS. 12 and 13 (e.g., by reversing airflow across the filter media). For example, the threshold value can be 25 inches of water (e.g., approximately 1 pound per square inch). In other words, the dust air pressure sensor 78 will measure pressure corresponding to the vacuum in the tank 12 used for loading the material. In an ideal case, the pressure measured by the clean air pressure sensor 80 in the clean air line 36 is the same corresponding to a vacuum provided by the blower being the same across the filter media. However, as the filter media becomes obstructed, the vacuum in the tank 12 will be decreased relative to the vacuum in the clean air line 36 provided by the blower. Once this differential pressure reaches the threshold value (e.g., approximately 1 pound per square inch), the control system 76 can actuate the valves for a cleaning cycle. Advantageously, this allows for the control system 76 to better maintain the vacuum in the tank 12 for efficient loading of the material. The control system 76 can display pressure readings from the sensors, differential pressure, and/or additional information. This can allow an operator of the system to manually control the loading, cleaning, or other processes as desired based on the provided information.

In alternative embodiments, the cleaning cycle is actuated manually using the control system 76 or manually in the absence of a control system by manipulating the corresponding valves. In such alternative embodiments with a control system 76, the control system 76 can provide differential pressure information, a warning, or the like that indicates to a user that a cleaning cycle should be effectuated.

In some embodiments, the control system provides for additional functions. For example, the control system 76 can used to automatically clean the filter media based on elapsed time. In such an embodiment, the control system 76 can start a timer based on detected position of the one or more valve positions associated with loading the tank 12. Once the timer has elapsed, the control system 76 can control the valves to clean the filter media (e.g., as will be described in greater detail with respect to FIGS. 12-13). After the cleaning, the control system 76 can control the valves to resume loading material and can reset the timer for future cleaning. For example, in some embodiments, the control system 76 automatically cleans the filter media every 10 minutes. In some embodiments, the control system 76 allow for manual triggering of the cleaning cycle by pushing a corresponding button (e.g., button 79). Upon registering the input, the control system 76 triggers the cleaning cycle. The control system 76 can also allow for an operator to select loading by the front fill pipe 69 or the rear fill pipe 70 (e.g., using buttons 81 and 83, respectively). This causes the control system 76 to appropriately actuate the corresponding valves 72, 74. Similarly, the control system 76 can close both fill pipe valves 72, 74 upon registering an input from a corresponding button 85. In some embodiments, the control system 76 further includes a button 87 to control the operation of the aerators 54. For example, upon receiving an input signal from button 87, the control system can actuate the aeration valve 56 to an open position providing air to the aerators 54. The control system 76 can provide such control using any suitable scheme including, for example, opening and then closing the valve after a predetermined period of time elapses, opening and then closing the valve when a coextensive automatic or manual clean operation has concluded, opening the valve and then closing the valve when receiving another input signal from button 87 (e.g., the button 87 operating as a toggle), using the button 87 as toggle which provides aeration or does not provide aeration, depending on toggle state, when other cleaning operations are triggered (e.g., automatic or manual cleaning), etc. It should also be noted that the control system 76 can include further components such as status indicator lights 89, display screens 91, or the like for conveying information (e.g., pressure sensor values, determined differential pressure, time remaining on operations such as cleaning, valve states, etc.).

In alternative embodiments, the pressure sensors and/or the control system 76 can be mechanical rather than electrical. For example, the control system can be implemented using pneumatic control elements, hydraulic control elements, or the like.

Referring now to FIGS. 12-13, operation of the valves for loading the tank and for cleaning the filter media and/or canister 22 is explained in greater detail. FIG. 12 illustrates the position of the relevant valves in filling the tank 12. FIG. 13 illustrates the position of the relevant valves in cleaning the filter media of the filtration system 14. In loading the tank 12, the dusty air inlet valve 32 and the vacuum shut off valve 40 are actuated to an open position. This allows for the blower to generate vacuum by pulling air through the fill pipe 16 and the tank 12 into the filtration system 14. Clean air exits the filtration system 14 and is expelled by the blower. In loading the tank 12, the dust recycle valve 62, the vacuum dump valve 44, and the atmospheric inlet valve 46 are actuated to the closed position. In embodiments including an aeration system, the optional aeration valve 56 is actuated to the closed position. By closing all valves in fluid communication with the atmosphere, the blower is capable of building a vacuum in the tank 12 to convey material into the tank 12.

When cleaning of the filter media is desired (e.g., by automatic control of the control system 76, manual control, etc.), the valves are actuated to reverse the flow of air across the filter media. The vacuum shut off valve 40 is closed to prevent the blower from continuing to build vacuum in the tank 12. To relieve stress on the blower, the vacuum dump valve 44 is opened. This allows the blower to pull atmospheric air and discharge it at reduced load on the blower while the vacuum shut off valve 40 being closed prevents further vacuum from being built in the tank 12. Opening the vacuum dump valve 44 also allows the blower to draw atmospheric air to cool the blower. To reverse the flow of air across the filter media to dislodge built up material, air must be provided. To provide air for this purpose, the atmospheric inlet valve 46 is opened. Because the atmospheric inlet valve 46 is in fluid communication with the atmosphere and in fluid communication with the tank 12 which is under residual vacuum from the loading process, the vacuum in the tank 12 draws air through the atmospheric inlet valve 46. The air crosses the filter media in reverse to the loading operation and dislodges material built up on the other side of the filter media. In embodiments including the air inlet filter 48, the atmospheric air is drawn through the filter then through the atmospheric inlet valve 46 and into the canister 22. The dust recycle valve 62 is also opened to allow the dust and material removed from the filter material and/or material collected in the canister 22 to be returned to the tank 12 (again under vacuum from the tank 12) through the dust recycle line 64. As previously noted, positioning the dust recycle line 64 low on the canister 22 provides for greater collection of the dust/material. When cleaning the filter media, the dusty air inlet valve 32 is also closed to promote return of the material from the bottom of the canister 22.

In embodiments that include aerators 54, the aeration valve 56 is also opened during cleaning. This provides aeration to the material collected in the bottom of the canister 22. The aeration facilitates the removal of the material from the canister in cleaning. The aeration valve 56 is closed when loading the tank 12.

Advantageously, cleaning the filter media using the residual vacuum in the tank 12 allows for cleaning while loading continues. This is because the vacuum in the tank 12 also continues to draw in the material being loaded while the filter media 23 is cleaned by reversed air flow. Also, the return of cleaned material through the dusty air inlet 20 rather than a fill pipe 16 further aides in the continued filling of the tank 12. This allows for material to continue moving into the tank 12 from the fill pipe 16 while cleaned material also flows into the tank 12 without being impeded by or impeding loading through the fill pipe 16. Cleaning the filter media and/or canister 22 while loading continues increases the loading efficiency as loading does not need to cease while the filter media is cleaned allowing for operation at improved efficiency (e.g., with a clean filter media). The filter media can also be cleaned when loading is complete to recycle the collected material from the canister 22 into the tank 12. This maximizes the amount of the material that is transported and unloaded (e.g., not leaving material behind in the canister 22). This allows for more material to be transported. It also prevents the need and expense in disposing of material from the canister 22.

It should be understood, as previously noted, that operation of the valves as described can be fully automatic, partially automatic (e.g., in response to a manual control system 76 input), or can be entirely manual with manually actuated valves.

In alternative embodiments, the filtration system 14 and/or the conveyance system of the dry bulk tank trailer 10 can use other systems to reverse air flow across the filter media for cleaning (e.g., as opposed to relying on the residual vacuum in the tank 12). For example, a pressure line being output from a blower can be in fluid communication with the clean air side of the filter material (e.g., a blower output can be in fluid communication with the clean air line 36 and a valve to control reverse flow into the clean air line 36). The valve can be actuated to allow for clean air from the blower to be returned, in reverse flow, back into the canister 22 for cleaning the filter material. The dust recycle valve 62 is opened and the dusty air inlet line valve 32 is closed.

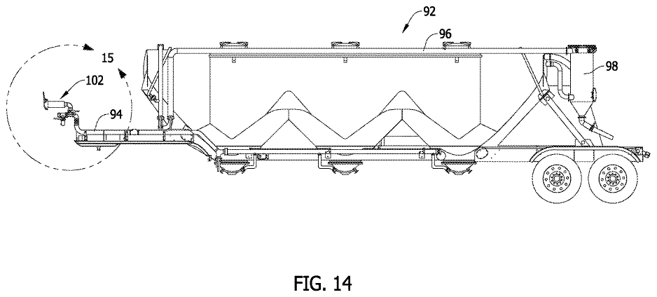

FIG. 14 is a representation of a side elevation view of a dry bulk tank trailer 92 that has a basic construction. The trailer 92 has a vacuum line 94 that supplies vacuum pressure to a tank 96 of the trailer. The vacuum line 94 is connected in fluid communication with a filter canister 98 and then is connected in fluid communication with the tank 96. Vacuum pressure supplied by the vacuum line 94 to the tank 96 loads the tank with dry bulk material conveyed in air drawn by the vacuum pressure from a source of the dry bulk material to the tank. The air drawn to the tank 96 is then drawn through the filter canister 98 to clean the bulk material dust from the air. The basic construction of the trailer 92 of FIG. 14 does not include the cleaning mode of operation or the filter cleaning features of the dry bulk tank trailer 10 of the application described with reference to FIGS. 1-13.

Also represented in FIG. 14 is an add on assembly 102 that is constructed as a single transportable unit configured to be manually transportable to a separate bulk tank trailer and to be manually transportable away from the bulk tank trailer. The add on assembly 102 can be manually carried or transported to and removably connected to the clean air line 94 of one or more separate dry bulk tank trailers 92 such as that represented in FIG. 14 to provide each dry bulk trailer with the ability to clean dust from the filter of the filter canister 98 when needed. The add on assembly can be removed from and transported away from the bulk tank trailer when the filter cleaning is completed. The add on assembly 102 adapts the trailer 92 to reverse the flow of air through the filter canister 98 to clean the filter in basically the same manner as described with reference to FIGS. 1-13.

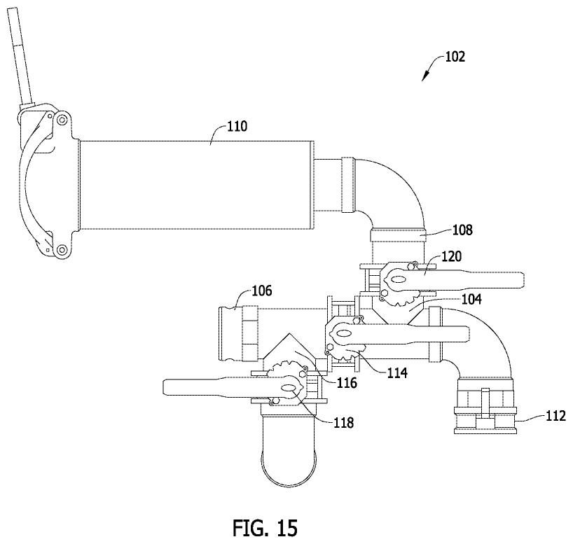

The add on assembly 102 is shown removed from the clean air line 94 of the dry bulk trailer 92 in FIG. 15. The add on assembly 102 comprises a manifold 104 that functions in the same manner as the clean air line fitting 38 of FIGS. 1-13. The manifold 104 has a plurality of branches or pipe connections that are all interconnected in fluid communication inside the manifold.

The plurality of pipe connections of the manifold 104 include a first branch or first pipe connection 106 of the plurality of pipe connections. The first pipe connection 106 is releasably connectable to a vacuum line that communicates with the vacuum source of the trailer 92. The vacuum source can be a blower of a truck cab connected to the trailer 92 or some other equivalent vacuum pressure source that is separate from the trailer 92 and the add on assembly 102. The first pipe connection or vacuum line connector 106 supplies vacuum pressure to the manifold 104 when the first pipe connection 106 is releasably connected to the vacuum line. The first pipe connection 106 could also be releasably connected to a source of positive pressure to communicate the positive pressure to the manifold 104 and the trailer 92.

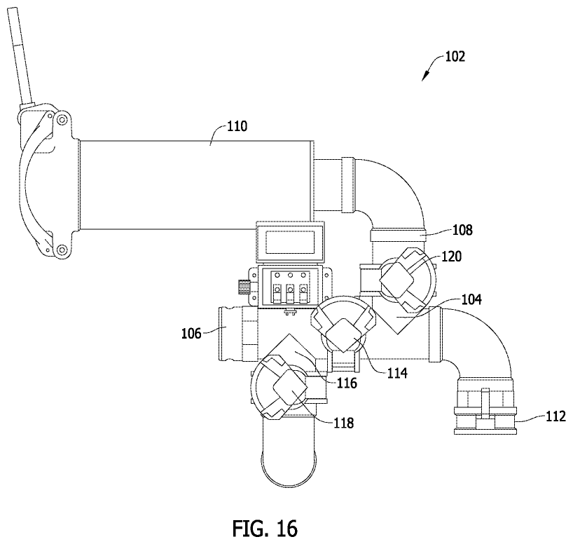

The pipe connections of the manifold 104 also include a second branch or second pipe connection 108. The second branch or second pipe connection 108 communicates with the air of the environment of the manifold 104. The second pipe connection 108 could be releasably connectable to a filter assembly 110 such as that shown in FIGS. 14 and 16 to filter the air of the environment of the manifold 104 prior to the air entering the manifold 104. The filter assembly 110 cleans atmospheric air drawn through the filter and into the manifold 104 in response to the first pipe connection 106 on the manifold 104 being releasably connected to the vacuum line that supplies vacuum pressure to the manifold. The filter 110 functions in a similar manner to the inlet air filter 48 described earlier.

Furthermore, the pipe connections of the manifold 104 include a third branch or third pipe connection 112 that is releasably connectable to the clean air line 94 of the trailer 92. With the third pipe connection 112 of the manifold 104 releasably connected to the clean air 94 and the first pipe connection 106 of the manifold releasably connected to the vacuum line, the manifold supplies vacuum pressure through the clean air line to the tank 96 and the filter canister 98 of the trailer 92 in a similar manner to the clean air line 36 described earlier

Thus, as described above, the manifold 104 functions in a similar manner to the clean air line fitting 38 described earlier.

A vacuum shut off valve 114 is connected to and in fluid communication with the first branch or first pipe connection 106 of the manifold 104. The vacuum shut off valve 114 can be a manually operated valve as shown in FIG. 15 or an electrically operated valve as shown in FIG. 16 or any other type of valve. The vacuum shut off valve 114 functions in the same manner as the vacuum shut off valve 40 described earlier.

A vacuum dump fitting 116 and a vacuum dump valve 118 are connected to and in fluid communication with the first branch or first pipe connection 106 of the manifold 104. The vacuum dump valve 118 can be a manually operated valve as shown in FIG. 15 or an electrically operated valve as shown in FIG. 16 or any other type of valve. The vacuum dump valve 118 functions in the same manner as the vacuum dump valve 44 described earlier.

An atmospheric inlet valve 120 is connected to and in fluid communication with the second branch or second pipe connection 108 of the manifold. The atmospheric inlet valve 120 can be a manually operated valve as shown in FIG. 15 or electrically operated valve as shown in FIG. 16 or any other type of valve. The atmospheric inlet valve 120 functions in the same manner as the atmospheric inlet valve 46 described earlier. FIG. 16 also shows a filter assembly 110 connected to the second branch or second pipe connection 108 of the manifold 104.

When assembled, the manifold 104, the filter assembly 110, the vacuum shut off valve 114, the vacuum dump valve 118 and the atmospheric inlet valve 120 are all manually transportable or can be manually carried together to the trailer 92 and connected to the vacuum line 94 when needed for cleaning the filter media 23 of the filter canister 22, and disconnected from the vacuum line 94 and transported away from the trailer when cleaning of the filter media 23 and filter canister 22 is completed.

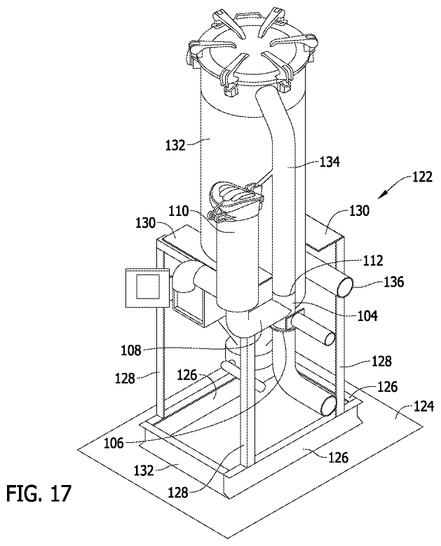

FIGS. 16-18 show representations of a framework 122 that is connected to and supports the manifold 104 as well as the filter assembly 110, the vacuum shut off valve 114, the vacuum dump valve 118 and the atmospheric inlet valve 120 connected to the manifold. The framework is constructed of beams of metal or other equivalent materials in a configuration that supports the manifold 104 and connected filter assembly 110 and valves 114, 118, 120 stationery above a surface 124 with the framework 122 positioned on the surface. The framework 122 is comprised of four C channel bars 126 connected by welding or other equivalent means in a rectangular configuration to form a base of the framework 122. Four angle bar columns 128 are welded near the corners of the base and extend upward to a pair of plates 130 welded to the top ends of the columns 128.

A filter canister 132 that is an equivalent to the filter canister 22 of the trailer 10 is secured between the plates 130 by welding. The manifold 104 is suspended from the canister 132 by a clean air line 134 connected between a clean air outlet of the canister 132 and the third pipe connection or the third branch 112 of the manifold 104. A dusty air inlet 136 of the canister 132 is connected by a pipe or equivalent conduit to the dusty air inlet pipe 20 connected to the trailer tank 12. The second pipe connection or second branch 108 of the manifold 104 is connected to the atmosphere filter assembly 110 and the first pipe connection or first branch 106 of the manifold 104 is connected by a pipe or equivalent conduit to the vacuum line 24. This connects the filter canister 132 supported on the framework 122 for dust filtering operation provide for a separate bulk tank trailer and for filter cleaning operation.

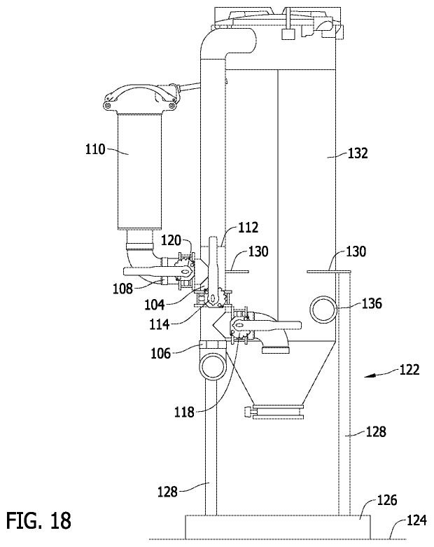

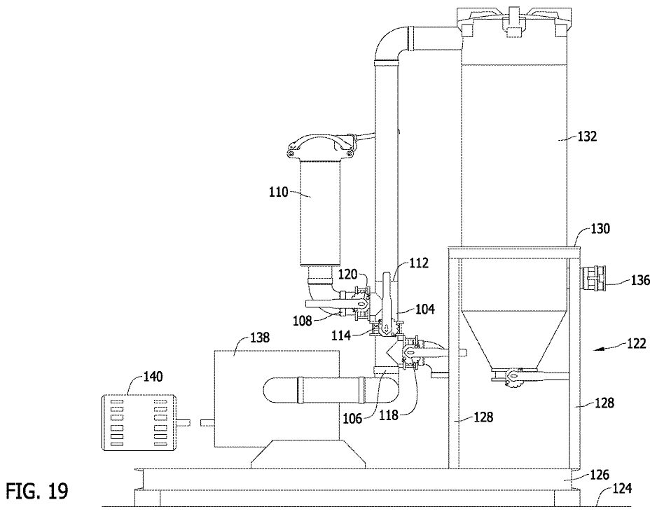

FIG. 18 represents a blower 138 driven by a motor 140 that are connected to the framework 122 and supported on the framework. The blower 138 and motor 140 can provide the source of vacuum pressure that replaces the vacuum line 24.

Changes can be made in the above constructions without departing from the scope of the disclosure. It is intended that all matter contained in the above description or shown in the accompanying drawings shall be interpreted as illustrative and not in a limiting sense. These examples are merely illustrative

I claim:

1. An add on assembly for a bulk tank trailer having a clean air line that communicates with a vacuum line that is connectable to a source of vacuum pressure to supply vacuum pressure to a tank of the bulk tank trailer, the add on assembly comprising:
a clean air line fitting, the clean air fitting having a plurality of branches that are all connected in fluid communication in the clean air line fitting;
a first branch of the plurality of branches of the clean air line fitting, the first branch being configured for releasable attachment to a vacuum line that is separate from the add on assembly whereby the vacuum line supplies vacuum pressure to the clean air line fitting when the first branch is releasably attached to the vacuum line;
a second branch of the plurality of branches of the clean air line fitting, the second branch being configured to communicate with air of an environment of the manifold and communicate the air of the environment into the clean air line fitting in response to the first branch of the clean air line fitting being releasably attached to a vacuum line that supplies vacuum pressure to the clean air line fitting; and
a third branch of the plurality of branches of the clean air line fitting, the third branch being configured for releasable attachment to a clean air line of a bulk tank trailer that is separate from the add on assembly whereby the clean air line supplies vacuum pressure to the tank of the bulk tank trailer in response to the first branch of the clean air line fitting being releasably attached to a vacuum line that supplies vacuum pressure to the clean air line fitting.

2. The add on assembly of claim 1, further comprising:
the clean air fitting and the filter attached to the second branch of the clean air fitting being manually transportable together.

3. The add on assembly of claim 1, further comprising:
a vacuum shut off valve attached to the first branch of the clean air fitting;
an atmospheric inlet valve attached to the second branch of the clean air fitting; and
a vacuum dump fitting and a vacuum dump valve attached to the first branch of the clean air fitting.

4. The add on assembly of claim 3, further comprising:
the clean air line flitting, the vacuum shut off valve, the atmospheric inlet valve, the vacuum dump fitting and the vacuum dump valve all being manually transportable together.

5. The add on assembly of claim 3, further comprising:
the vacuum shut off valve, the atmospheric inlet valve, and the vacuum dump valve all being manually operable valves.

6. The add on assembly of claim 1, further comprising:
a framework attached to the clean air fitting, the framework being configured to support the clean air line fitting positioned stationary above a surface in response to the framework being positioned on the surface.

7. The add on assembly of claim 6, further comprising:
the framework being manually transportable.

8. The add on assembly of claim 6, further comprising:
a filter canister attached to the framework, the framework being configured to support the filter canister positioned stationary above a surface in response to the framework being positioned on the surface.

9. The add on assembly of claim 6, further comprising:
a blower connected in fluid communication with the vacuum line, the blower being configured to supply vacuum pressure to the vacuum line in response to operation of the blower;
a motor operatively connected with the blower, the motor being configured to operate the blower; and
the blower and the motor being attached to the framework, the framework being configured to support the blower and the motor positioned stationary above a surface in response to the framework being positioned on the surface.

10. The add on assembly of claim 1, further comprising:
a blower connected in fluid communication with the vacuum line, the blower being configured to supply vacuum pressure to the vacuum line in response to operation of the blower; and
a motor operatively connected with the blower, the motor being configured to operate the blower.

11. An add on assembly for a bulk tank trailer having a vacuum line that is connectable to a source of vacuum pressure to supply vacuum pressure to a tank of the bulk tank trailer, the add on assembly comprising:
a manifold, the manifold having a plurality of pipe connections that are all connected in fluid communication inside the manifold;
a first pipe connection of the plurality of pipe connections on the manifold, the first pipe connection being configured for releasable connection to a vacuum line that is separate from the add on assembly whereby the vacuum line supplies vacuum pressure to the manifold when the first pipe connection is releasably connected to the vacuum line;
a second pipe connection of the plurality of pipe connections on the manifold, the second pipe connection being configured to communicate with air of an environment of the manifold and communicate the air of the environment into the manifold in response to the first pipe connection on the manifold being releasably connected to a vacuum line that supplies vacuum pressure to the manifold; and
a third pipe connection of the plurality of pipe connections on the manifold, the third pipe connection being configured for releasable connection to a clean air line of a bulk tank trailer that is separate from the add on assembly whereby the clean air line supplies vacuum pressure to the tank of the bulk tank trailer in response to the first pipe connection on the manifold being releasably connected to a vacuum line that supplies vacuum pressure to the manifold.

12. The add on assembly of claim 11, further comprising:
the second pipe connection on the manifold being connected to a filter, and the manifold and filter connected to the manifold being manually transportable together.

13. The add on assembly of claim 11, further comprising:
a vacuum shut off valve connected to the first pipe connection of the manifold;
an atmospheric inlet valve connected to the second pipe connection of the manifold; and
a vacuum dump fitting and a vacuum dump valve connected to the first pipe connection of the manifold.

14. The add on assembly of claim 13, further comprising:
the manifold, the vacuum shut off valve, the atmospheric inlet valve, the vacuum dump fitting and the vacuum dump valve all being manually transportable together.

15. The add on assembly of claim 13, further comprising:
the vacuum shut off valve, the atmospheric inlet valve, and the vacuum dump valve all being manually operable valves.

16. The add on assembly of claim 11, further comprising:
a framework attached to the manifold, the framework being configured to support the manifold positioned stationary above a surface in response to the framework being positioned on the surface.

17. The add on assembly of claim 16, further comprising:
the framework being manually transportable.

18. The add on assembly of claim 16, further comprising:
a filter canister attached to the framework, the framework being configured to support the filter canister positioned stationary above a surface in response to the framework being positioned on the surface.

19. The add on assembly of claim 11, further comprising:
a blower connected in fluid communication with the vacuum line, the blower being configured to supply vacuum pressure to the vacuum line in response to operation of the blower;
a motor operatively connected with the blower, the motor being configured to operate the blower; and
the blower and the motor being attached to the framework, the framework being configured to support the blower and the motor positioned stationary above a surface in response to the framework being positioned on the surface.

20. The add on assembly of claim 1, further comprising:
a blower connected in fluid communication with the vacuum line, the blower being configured to supply vacuum pressure to the vacuum line in response to operation of the blower; and
a motor operatively connected with the blower, the motor being configured to operate the blower.
